(19) United States
(12) Patent Application Publication
(10) Pub. No.: US 2012/0070205 A1
(43) Pub. Date: Mar. 22, 2012

(54) FIXING UNIT AND IMAGE FORMING APPARATUS

(75) Inventors: Sho WATANABE, Kanagawa (JP); Yuichi FUKUDA, Kanagawa (JP); Chikara ANDO, Kanagawa (JP); Toshiyuki MIYATA, Kanagawa (JP); Masaya NAKATSUHARA, Kanagawa (JP)

(73) Assignee: FUJI XEROX CO., LTD., Tokyo (JP)

(21) Appl. No.: 13/028,695

(22) Filed: Feb. 16, 2011

(30) Foreign Application Priority Data
Sep. 16, 2010 (JP) 2010-208112

(51) Int. Cl. G03G 15/20

(52) U.S. Cl. 399/328; 399/329

(57) ABSTRACT

A fixing unit includes: a fixing member; a pressure member that rotates while being pressed onto the fixing member; a fixing portion that is a contact portion between the fixing member and the pressure member and performs fixation on a recording medium; and a temperature uniformizing member that abuts against the pressure member on a rotational downstream side of the pressure member with respect to the fixing portion and over an area longer than an axial length of the recording medium perpendicular to a conveyance direction of the recording medium.

### CROSS-REFERENCE TO RELATED APPLICATIONS

This application is based on and claims priority under 35 USC 119 from Japanese Patent Application No. 2010-208112 filed on Sep. 16, 2010.

### BACKGROUND

### Technical Field

The present invention relates to a fixing unit and an image forming apparatus.

### SUMMARY

According to an aspect of the invention, there is provided a fixing unit including: a fixing member; a pressure member which rotates while being pressed onto the fixing member; a fixing portion which is a contact portion between the fixing member and the pressure member and performs fixation on a recording medium; and a temperature uniformizing member which abuts against the pressure member on a rotational downstream side of the pressure member with respect to the fixing portion and over an area longer than an axial length of the recording medium perpendicular to a conveyance direction of the recording medium.

### BRIEF DESCRIPTION OF THE DRAWINGS

Exemplary embodiments of the present invention will be described in detail based on the following figures, wherein:

FIG. 1 is a schematic view showing the whole of an image forming apparatus according to an exemplary embodiment of the invention;

FIG. 2 is a schematic view showing the whole of a fixing unit according to the exemplary embodiment of the invention;

FIG. 3 is a sectional view showing a main portion of the fixing unit according to the exemplary embodiment of the invention;

FIG. 4 is a sectional view showing a main portion of a fixing unit according to a modification of the exemplary embodiment of the invention; and

FIG. 5 is a schematic view showing the whole of the fixing unit according to the modification of the exemplary embodiment of the invention.

### DETAILED DESCRIPTION

### (1) Fundamental Configuration and Operation of Image Forming Apparatus

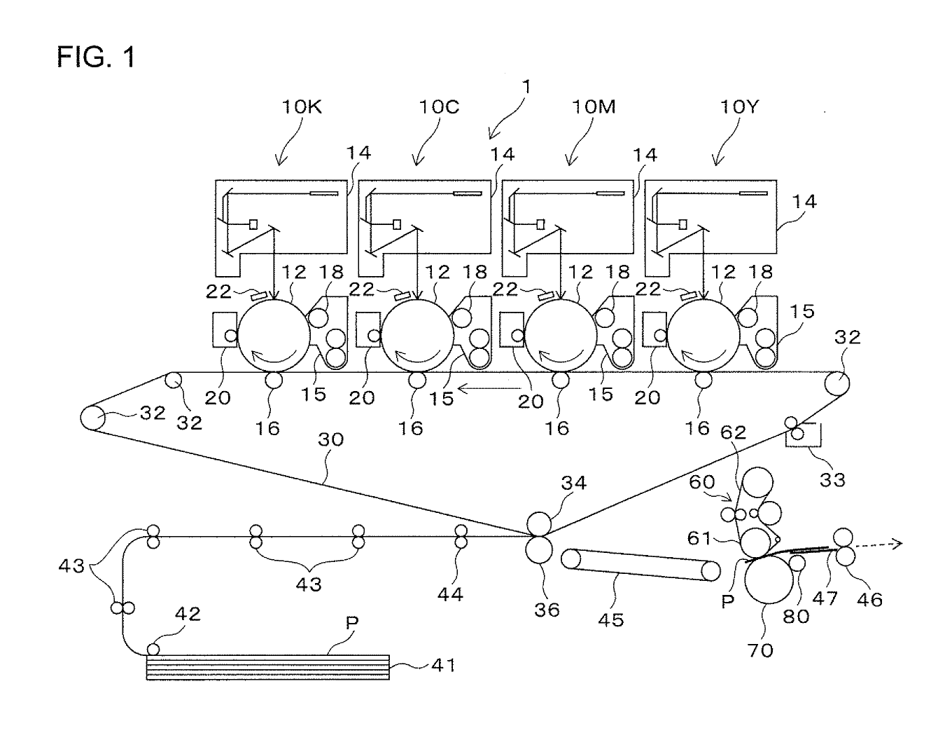

As shown in FIG. 1, this image forming apparatus 1 performs image processing based on color image information obtained by reading out a document or color image information sent from an image data input apparatus such as a personal computer, and forms a color image on a sheet P by electrophotography. The sheet P is an example of a recording medium. Examples of recording media include resin sheets such as OHP sheets as well as paper sheets.

The image forming apparatus 1 has image forming units 10Y, 10M, 100 and 10K as examples of image forming portions for forming toner images of respective colors, i.e. yellow (Y), magenta (M), cyan (C) and black (K). The image forming units 10Y, 10M, 100 and 10K are arrayed in series in the named order with respect to a traveling direction of an endless intermediate transfer belt 30 stretched by a backup roll 34 and a plurality of rolls 32. In addition, the intermediate transfer belt 30 passes between a photoconductor drum 12 as an image retainer constituting each image forming unit 10Y, 10M, 100, 10K and a primary transfer roll 16 disposed oppositely to the photoconductor drum 12, and between the backup roll 34 and a secondary transfer roll 36 as an image transfer portion in contact with the backup roll 34.

Further, a charger 22, an exposure unit 14, a development unit 15 and a photoconductor cleaner 20 are provided around each photoconductor drum 12. The charger 22 charges the surface of the photoconductor drum 12 uniformly. The exposure unit 14 serves as an exposure unit which irradiates the surface of the photoconductor drum 12 with light to form an electrostatic latent image on the surface of the photoconductor drum 12. The development unit 15 visualizes the electrostatic latent image with toner to form a toner image. The photoconductor cleaner 20 removes transfer residual toner or the like from the surface of the photoconductor drum 12.

A sheet feed unit 41 is disposed in a lower portion of the image forming apparatus 1. A pickup roll 42 for picking up the uppermost one of stacked sheets P is disposed above a left end portion of the sheet feed unit 41. On a left side of the pickup roll 42, a conveyance path is bent upward by a guide or the like. Paired conveyance rolls 43 are disposed on a downstream side of the upward bent portion of the conveyance path. The conveyance path is further bent right by a guide or the like, and paired conveyance rolls 43 are disposed on a downstream side of the right bent portion of the conveyance path. Paired registration rolls 44 for suspending the sheet P and correcting the tilted state thereof are disposed on the downstream side of the paired conveyance rolls 43. The aforementioned pair of the backup roll 34 and the secondary transfer roll 36 are disposed on a downstream side of the paired registration rolls 44. On the right side of the pair of the backup roll 34 and the secondary roll 36, a fixing unit 60 is disposed with a conveyance belt 45 interposed therebetween. Paired output rolls 46 and an output guide 47 are disposed on a downstream side of the fixing unit 60. The configuration of the fixing unit 60 will be described in detail later.

Next, the operation of image formation to be performed by the image forming unit 10Y for forming a yellow toner image will be described representatively.

The surface of the photoconductor drum 12 provided in the image forming unit 10Y is charged uniformly by the charger 22. Further, the exposure unit 14 emits a light beam onto the photoconductor drum 12 based on image data to perform exposure corresponding to a yellow image. Thus, an electrostatic latent image corresponding to the yellow image is formed on the surface of the photoconductor drum 12.

The electrostatic latent image corresponding to the yellow image on the photoconductor drum 12 is developed with toner retained on a developing roll 18 of the development unit 15 so as to be formed as a yellow toner image. The yellow toner image is primarily transferred onto the intermediate transfer belt 30 by the pressure of the primary transfer roll 16 and an electrostatic attraction force of transfer bias applied to the primary transfer roll 16.

In this primary transfer, the yellow toner image is not wholly transferred onto the intermediate transfer belt 30 but partially remains on the photoconductor drum 12. In addition, an external additive to the toner or the like also adheres to the surface of the photoconductor drum 12. The photoconductor drum 12 after the primary transfer is passed through a position opposed to the photoconductor cleaner 20, so that transfer residual toner etc. on the photoconductor drum 12 is removed. After that, the surface of the photoconductor drum 12 is charged again by the charger 22 for the next image formation cycle.

In addition, in the image forming apparatus 1, an image forming process the same as the aforementioned image forming process is performed in the respective color image forming units 10Y, 10M, 10C and 10K at timings in which a relative position gap between adjacent ones of the image forming units 10Y, 10M, 10C and 10K has been taken into consideration. Thus, toner images of the respective colors Y, M, C and K are superposed sequentially on the intermediate transfer belt 30 so as to form multiple toner images on the intermediate belt 30.

Then, by the electrostatic attraction force of the secondary transfer roll 36 to which transfer bias is applied, the multiple toner images are collectively transferred from the intermediate transfer belt 30 to the sheet P which is, for example, conveyed from the sheet feed unit 41 via the pickup roll 42 and the paired conveyance rolls 43 to the secondary transfer roll 36 at a conveyance timing determined by the registration rolls 44. Toner etc. which has not been transferred to the sheet P but remains on the intermediate transfer belt 30 is recovered by a belt cleaner 33.

Further, the sheet P to which the multiple toner images have been transferred from the intermediate transfer belt 30 is conveyed to the fixing unit 60, by which the multiple toner images are fixed to the sheet P by heat and pressure. Thus, a full color image is formed on the sheet P. After that, the sheet P is outputted through the output guide 47 and the paired output rolls 46.

### (2) Configuration of Fixing Unit

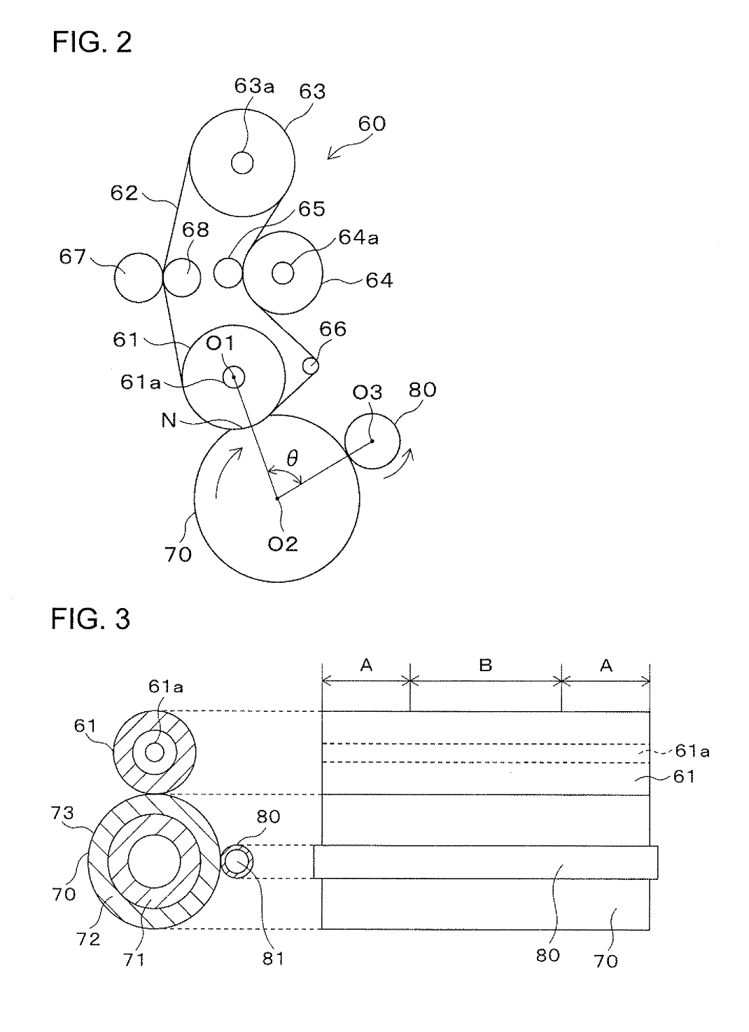

Next, the configuration of the fixing unit 60 will be described with reference to FIGS. 2 and 3. In these drawings, the reference numeral 61 represents a fixing roll as an example of a support member. The fixing roll 61 is a cylindrical roll formed out of aluminum or the like. A halogen lamp 61a as an example of a heating unit is provided inside the fixing roll 61 to extend all over the length of the fixing roll 61. The halogen lamp 61a is designed so that different temperatures can be set in accordance with the axial position of the fixing roll 61. The fixing roll 61 is rotated counterclockwise in FIG. 2 by a not-shown drive mechanism.

As shown in FIG. 3, an area represented by the reference sign B is a contact area where an A4-size sheet P conveyed with its long side against the conveyance direction should abut against the fixing roll 61 and a pressure roll 70 which will be described later. In the following description, this contact area will be referred to as “sheet-pass area B”, and any other area outside the sheet-pass area B where any size sheet P should not abut against the fixing roll 61 and the pressure roll 70 will be referred to as “sheet-non-pass area A”. The halogen lamp 61a can make the temperature of the sheet-non-pass area A of the fixing roll 61 higher than the temperature of the sheet-pass area B or on the contrary make the temperature of the sheet-non-pass area A lower than the temperature of the sheet-pass area B.

A fixing belt 62 as an example of a fixing member is wound on the fixing roll 61. The fixing belt 62 is wound among tension rolls 63, 64, 65, 66, 67 and 68. Thus, a constant tension is applied to the fixing belt 62. Those tension rolls 63 and so on are formed out of aluminum or the like, and halogen lamps 63a and 64a each having a function equal to that of the halogen lamp 61a are provided inside the tension rolls 63 and 64 respectively.

The fixing belt 62 is an endless belt, which is constituted by a multilayer structure consisting of a base layer, a silicone rubber layer and a release layer. The base layer is formed out of polyimide resin or the like. The silicone rubber layer is laminated on the surface side (outer circumferential surface side) of the base layer. The release layer is further formed on the silicone rubber layer and out of tetrafluoroethylene-perfluoroalkyl vinyl ether copolymer resin (PFA) or the like.

The pressure roll 70 as an example of a pressure member is brought into pressure contact with the fixing roll 61 on which the fixing belt 62 is wound. In the pressure roll 70, as shown in FIG. 3, a silicone rubber layer 72 is formed on the outer circumference of a cylindrical core 71 formed out of aluminum or the like, and a release layer 73 made from PFA is provided on the outer circumference of the silicone rubber layer 72. The silicone rubber layer 72 pressed by the fixing roller 61 is elastically deformed to form a nip portion N as a fixing portion between the fixing roll 61 and the pressure roll 70. The pressure roll 70 is rotated clockwise in FIG. 2 with the movement of the fixing belt 62. When the sheet P is put between the fixing belt 62 and the pressure roll 70, the multiple toner images are fixed to the sheet P by heat and pressure of the fixing belt 62 to form a full color image.

A heat pipe 80 as an example of a temperature uniformizing member is brought into contact with the outer circumference of the pressure roll 70. The heat pipe 80 is longer than the axial length of the pressure roll 70. The heat pipe 80 has a function by which, when the pressure roll 70 has different temperatures at its portions, heat can be transferred from high temperature portions to low temperature portions so as to approximate the temperatures of those portions to a uniform state. In the heat pipe 80, a cylindrical pipe formed out of aluminum or the like is filled with water 81 as a heat transfer medium. The heat pipe 80 is rotatably supported in its opposite end portions, and pressed onto the pressure roll 70 by a not-shown spring. With rotation of the pressure roll 70, the heat pipe 80 rotates counterclockwise. Apart from the heat pipe filled with a heat transfer medium such as water, a round bar made from metal whose thermal conductivity is not lower than the thermal conductivity of copper (0.94 cal/cm·° C.·sec) may be used as the temperature uniformizing member.

The heat pipe 80 abuts against the pressure roll 70 in a position turned rotationally at an angle θ around the rotational center of the pressure roll 70 from the rotational center of the pressure roll 70 in the nip portion N between the fixing roll 61 and the pressure roll 70. That is, the center O3 of the heat pipe 80 is located in a position shifted in the rotational direction of the pressure roll 70 by the angle θ from the line segment connecting the center O1 of the fixing roll 61 with the center O2 of the pressure roll 70.

### (3) Operation of Fixing Unit

The sheet P to which the multiple toner images have been secondarily transferred enters the nip portion N between the fixing belt 62 and the pressure roll 70 from the left side in FIG. 2. The multiple toner images are fixed to the sheet P by the heat and pressure of the fixing belt 62. Thus, a full color image is formed on the sheet P. At that time, the fixing belt 62 is heated by the halogen lamp 61a of the fixing roll 61, or the like. In addition, the pressure roll 70 is heated by heat conduction from the fixing belt 62.

Here, it is preferable that the gloss level of an image is low when the image is formed. The gloss level can be lowered by decreasing the temperature of the fixing belt 62. However, when the temperature of the fixing belt 62 is decreased, there is a fear that a failure in fixation may occur. On the other hand, when the temperature of the pressure roll 70 is set to be high, the heat of the pressure roll 70 is transferred to the secondarily transferred toner from the sheet P so that the toner can be fused sufficiently in the sheet P side portion to be thereby connected firmly to the sheet P. In contrast, the fixing belt 62 side portion of the secondarily transferred toner suffers a small influence from the heat of the pressure roll 70 so that the gloss level can be suppressed to be low. Thus, by setting the temperature of the pressure roll 70 to be high without increasing the temperature of the fixing belt 62, the gloss level of the image can be suppressed to be low while the fixability is secured.

However, when image formation is continuously performed on a thick sheet P, a large part of heat is absorbed from the pressure roll 70 by the sheet P. In this respect, the heat pipe 80 is brought into contact with the outer circumference of the pressure roll 70 in this exemplary embodiment. As a result, even if the heat of the sheet-pass area B of the pressure roll 70 is absorbed by the sheet P, the heat of the sheet-non-pass area A can be transferred to the sheet-pass area B by the heat pipe 80 to approximate the temperature of the sheet-non-pass area A and the temperature of the sheet-pass area B to a uniform state. Thus, even in the case where image formation is continuously performed on the thick sheet P, the temperature decrease in the sheet-pass area B of the pressure roll 70 can be suppressed to thereby suppress the gloss level of the image to be low while ensuring the fixability. Incidentally, in this exemplary embodiment, the “thick sheet” designates a sheet which is not thinner than 82 g/m².

In this exemplary embodiment, the heat pipe 80 abuts against the pressure roll 70 in a position turned rotationally at an angle θ from the rotational center of the pressure roll 70 in the nip portion N between the fixing roll 61 and the pressure roll 70, and the heat pipe 80 is disposed on the downstream side of the nip portion N and closely to the nip portion N. In the surface of the pressure roll 70 immediately after the sheet S has passed through the nip portion N, the temperature of the sheet-pass area B drops down, and there is a great difference in temperature between the sheet-pass area B and the sheet-non-pass area A. As a result, heat is efficiently transmitted between the sheet-pass area B and the sheet-non-pass area A by the heat pipe 80 so that the temperature of the sheet-pass area B and the temperature of the sheet-non-pass area A can be approximated to a more uniform state. It is therefore desired that the heat pipe 80 is disposed to be as close to the nip portion N as possible. Preferably, the angle θ is set to be not larger than 90° or not larger than 60°.

Here, when the heat pipe 80 is not provided as in this exemplary embodiment, it can be considered that a heating unit such as a halogen lamp is provided inside the pressure roll 70 as a unit for suppressing temperature decrease in the pressure roll 70. However, the pressure roll 70 is provided with the silicone rubber layer 72 on the outer circumference of the core 71. The thermal conductivity of the silicone rubber layer 72 is low. Therefore, it is difficult to increase the surface temperature of the pressure roll 70 quickly while the configuration of the pressure roll 70 is complicated. Thus, also in view of the manufacturing cost, realizability is low. On the other hand, when a heating unit for increasing the surface temperature of the pressure roll 70 is provided outside the pressure roll 70, the manufacturing cost may be relatively increased so that realizability is low. When the temperature of the fixing belt 62 is set to be high enough to suppress the temperature decrease of the pressure roll 70, the gloss level of an image may be increased.

In respect of this point, according to this exemplary embodiment, the temperature decrease of the pressure roll 70 can be suppressed without requiring a new heating unit and without increasing the temperature of the fixing belt 62.

In addition, according to this exemplary embodiment, the condition to heat the fixing belt 62 is changed in accordance with the size or thickness of the sheet P. For example, all the halogen lamps 61a, 63a and 64a are turned on when the sheet P is of A3 size, and one of the halogen lamps 61a, 63a and 64a is turned off when the sheet P is of B5 size. Such control is performed based on the size of sheets P received in the sheet feed unit 41.

In addition, also in the configuration in which the fixing roll 61 is pressed onto the pressure roll 70 not through the fixing belt 62 but directly, the current conduction to the halogen lamp 61a is changed in accordance with the size or thickness of the sheet P. When the size of the sheet P is changed from a large size to a small size in such a configuration, the temperature distribution of the fixing roll 61 will be kept in the condition for the large-size sheet P for a while even if the current conduction to the halogen lamp 61a is changed. As a result, an uneven gloss level may occur in a formed image due to a difference in temperature in a corresponding portion of the fixing roll 61 to the small-size sheet P.

With respect to this point, according to the aforementioned exemplary embodiment, fixation is performed by the fixing belt 62 whose heat capacity is small. Thus, the temperature difference among positions of the fixing belt 62 can be approximated to a uniform state rapidly, so that occurrence of an uneven gloss level can be suppressed.

### (4) Modifications of Exemplary Embodiment

In the aforementioned exemplary embodiment, temperatures set in the halogen lamps 61a, 63a and 64a may be changed in accordance with axial positions so as to set the temperature of the sheet-non-pass area A of the fixing belt 62 to be higher than the temperature of the sheet-pass area B. Even if the temperature of the fixing belt 62 in the sheet-non-pass area A is increased, no influence will be given to the gloss level of an image, but the temperature decrease of the pressure roll 70 in the sheet-pass area B can be suppressed effectively due to the increased amount of heat transmitted from the sheet-non-pass area A to the sheet-pass area B through the heat pipe 80.

On the contrary, the temperature of the sheet-non-pass area A of the fixing belt 62 may be set to be lower than the temperature of the sheet-pass area B. When an image is formed continuously on a thin sheet P, the temperature of the pressure roll 70 may be increased excessively due to the small amount of heat absorbed from the pressure roll 70. In such a case, the image may be granulated due to the expansion of vapor from the sheet P which is being fixed. To solve such a problem, the temperature of the fixing belt 62 is set as described above. Thus, the temperature of the pressure roll 70 can be prevented from increasing excessively. In this exemplary embodiment, “thin sheet” designates a sheet which is thinner than 82 g/m².

Next, when an image is formed on a thick sheet P, the temperature of the pressure roll 70 is set to be higher than when an image is formed on a thin sheet P, in consideration of the amount of heat which will be absorbed by the sheet P. If the temperature of the pressure 70 is kept high when the sheet for forming an image thereon is changed to a thin sheet P from a thick sheet P, the image will be granulated due to the expansion of vapor from the sheet P on which fixation is being performed. To solve this problem, as shown in FIG. 5, a fan 95 may be provided as an example of a spray unit which sprays the air to the pressure roll 70. The fan 95 cools the whole axial area of the pressure roll 70. The spray unit is not limited to the fan 95. Alternatively, a duct may be connected to an air blowing unit provided outside the fixing unit, while an end portion of the duct is made to face the pressure roll 70.

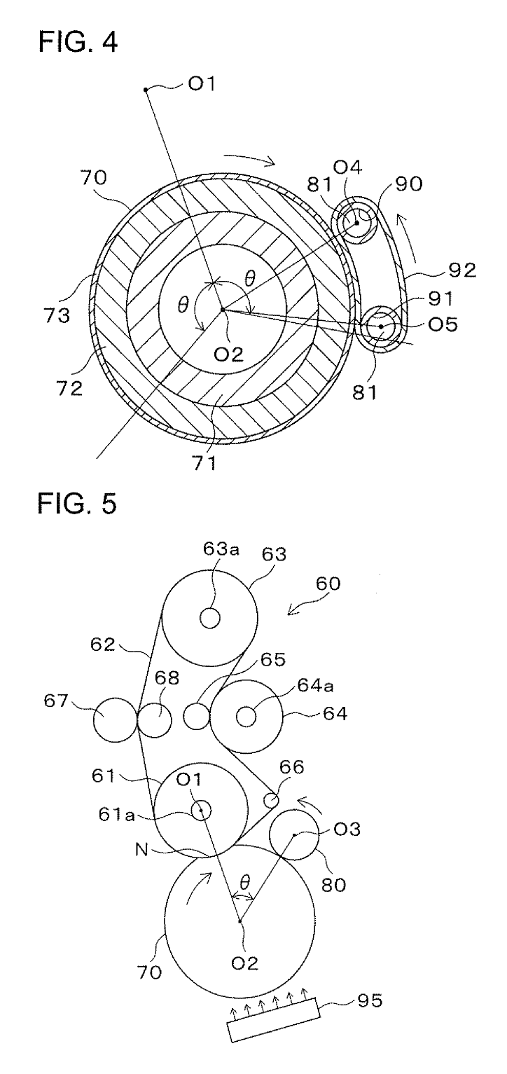

In addition, the heat pipe 80 is not limited to that in the aforementioned exemplary embodiment, but various changes may be made. For example, configuration can be made as shown in FIG. 4, so that an endless belt 92 may be wound around two rotatable heat pipes 90 and 91 while the belt 92 is pressed onto the pressure roll 70. In such a state, the heat transfer from the sheet-non-pass area A to the sheet-pass area B in the pressure roll 70 can be performed efficiently due to the plural heat pipes 90 and 91 and the surface contact between the belt 92 and the pressure roll 70.

The fixing unit according to the invention is applicable to image forming apparatuses such as printing machines, copying machines, printers, facsimile machines, and complex machines having the same functions as those of these machines.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A fixing unit comprising:
a fixing member;
a pressure member that rotates while being pressed onto the fixing member;
a fixing portion that is a contact portion between the fixing member and the pressure member and performs fixation on a recording medium; and
a temperature uniformizing member that abuts against the pressure member on a rotational downstream side of the pressure member with respect to the fixing portion and over an area longer than an axial length of the recording medium perpendicular to a conveyance direction of the recording medium.

2. A fixing unit comprising:
a fixing member;
a pressure member that rotates while being pressed onto the fixing member;
a fixing portion that is a contact portion between the fixing member and the pressure member and performs fixation on a recording medium; and
a temperature uniformizing member that abuts against the pressure member on a rotational downstream side of the pressure member with respect to the fixing portion and transports heat axially from the pressure member in a non-contact area with the recording medium to the pressure member in a contact area with the recording medium, so as to uniformize surface temperatures between the non-contact area and the contact area.

3. The fixing unit according to claim 1, further comprising: a heating unit that heats the fixing member, wherein a surface temperature of the fixing member in a portion that is axially outside a contact area with the recording medium when the recording medium passes through the fixing member is set to be higher than a surface temperature of the fixing member in the contact area.

4. The fixing unit according to claim 2, further comprising: a heating unit that heats the fixing member, wherein a surface temperature of the fixing member in a portion that is axially outside a contact area with the recording medium when the recording medium passes through the fixing member is set to be higher than a surface temperature of the fixing member in the contact area.

5. The fixing unit according to claim 1, further comprising: a heating unit that heats the fixing member, wherein a surface temperature of the fixing member in a portion that is axially outside a contact area with the recording medium when the recording medium passes through the fixing member is set to be lower than a surface temperature of the fixing member in the contact area.

6. The fixing unit according to claim 2, further comprising: a heating unit that heats the fixing member, wherein a surface temperature of the fixing member in a portion that is axially outside a contact area with the recording medium when the recording medium passes through the fixing member is set to be lower than a surface temperature of the fixing member in the contact area.

7. The fixing unit according to claim 1, further comprising: a spray unit that sprays air to the pressure member.

8. The fixing unit according to claim 2, further comprising: a spray unit that sprays air to the pressure member.

9. The fixing unit according to claim 1, wherein the fixing member comprises support members which rotate in opposition to the pressure member and an endless belt-like body that is stretched among the support members.

10. The fixing unit according to claim 2, wherein the fixing member comprises support members which rotate in opposition to the pressure member and an endless belt-like body that is stretched among the support members.

11. An image forming apparatus comprising:
an image forming portion that forms an image on a recording medium; and
the fixing unit according to claim 1, by which the image formed on the recording medium is fixed to the recording medium.

12. An image forming apparatus comprising:
an image forming portion that forms an image on a recording medium; and
the fixing unit according to claim 2, by which the image formed on the recording medium is fixed to the recording medium.
